(19) United States
(12) Patent Application Publication
(10) Pub. No.: US 2004/0192303 A1
(43) Pub. Date: Sep. 30, 2004

(54) Securing data of a mobile device after losing physical control of the mobile device

(76) Inventor: Jose P. Puthenkulam, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/236,447

(22) Filed: Sep. 6, 2002

(51) Int. Cl. H04Q 7/20

(52) U.S. Cl. 455/435.1; 455/411

(57) ABSTRACT

Mobile devices, such as communication devices, are frequently lost, stolen, misplaced, or otherwise temporarily or permanently indisposed while the device is storing personal and/or confidential data, such as telephone directories, calendars, account numbers, access codes, access rights to other data, and the like. For a mobile device needing to register itself with a system, the registration process is used to facilitate determining whether access to data associated with the mobile device mobile device data should be granted. For example, if the mobile device includes cellular communication capabilities, the data is secured until the device successfully registers with a cellular network. When registering the mobile device, a check is performed to determine whether loss of control over the mobile device has bee reported. If so, registration fails, and data access and mobile device communication capabilities may be partially or wholly restricted.

### FIELD OF THE INVENTION

The invention generally relates to mobile devices, and more particularly to securing data stored on or associated with a mobile device during registration of the mobile device within a system, for example, during registration of a cellular telephone or other mobile device with a cellular network.

### BACKGROUND

Miniaturization of electronics has made it possible for one to carry a mobile device in ones pocket that combines features once relegated to different and/or bulky pieces of hardware. For example, current mobile devices combine telephony, calendaring, contact management, task tracking, messaging, web browsing, and gaming features. Some mobile devices provide a generally accessible processor and allow the phone to be programmed and essentially operate as a mini portable computer.

A significant problem with such mobile devices is that they are frequently lost, stolen or misplaced after the mobile device has been encoded with personal and personally identifying data, such as private telephone directories, calendar entries, account numbers, and the like. Loss of a mobile device with such encoded information may represent a significant security issue for the phone owner. Currently, there are no convenient techniques for temporarily or permanently disabling a mobile device after it is out of the physical control of the owner of the mobile phone.

### BRIEF DESCRIPTION OF THE DRAWINGS

The features and advantages of the present invention will become apparent from the following detailed description of the present invention in which:

FIG. 1 illustrates a prior art cellular telephone system.

FIG. 2 illustrates a system according to one embodiment that provides for securing a mobile device after it is out of the control of its owner.

FIG. 3 is a flowchart according to one embodiment illustrating activation of a mobile device in the FIG. 2 system.

FIG. 4 illustrates a flowchart according to one embodiment for a FIG. 2 Device Client operating asynchronously to the operation of the mobile client.

FIG. 5 illustrates a suitable computing environment in which certain aspects of the invention may be implemented.

### DETAILED DESCRIPTION

The following description discusses various methods and devices which may be used to secure mobile devices such as a personal digital assistant, cellular telephone, portable computer, or other mobile device, that register their presence with a system in which the mobile device resides in order for the mobile device to operate within the system.

For expository convenience, the present disclosure is directed towards securing mobile devices that communicate with cellular telephone networks, as such mobile devices are frequently lost, stolen or misplaced after the mobile device has been encoded with personal and/or confidential information, such as telephone directories, calendar entries, account numbers, and other personal and personally identifying data. As will be appreciated by one skilled in the art, the principles and techniques disclosed herein may be applied to other mobile device environments.

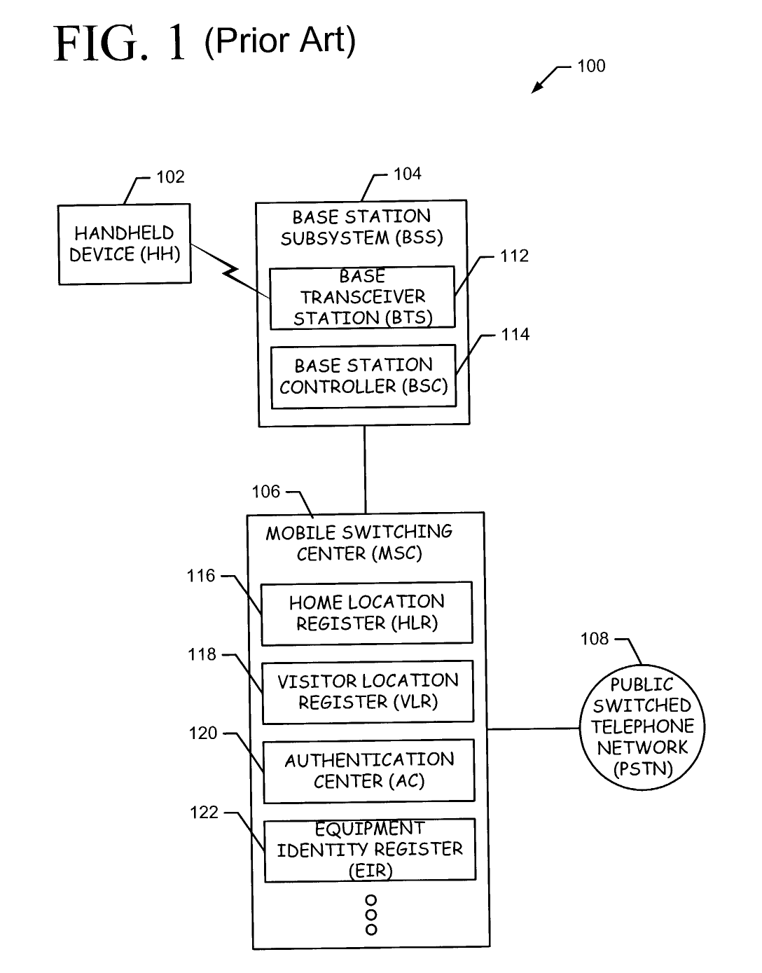

In order to appreciate more fully the invention, it is helpful to first discuss a conventional (prior art) cellular telephone system. FIG. 1 illustrates a prior art cellular telephone system 100 comprising a mobile device 102, such as cellular phone, a Base Station Subsystem (BSS) 104, a Mobile Switching Center (MSC) 106, and a coupling to a Public Switched Telephone Network (PSTN) 108. The ellipses in the MSC indicate other modules, not illustrated, may be present in a particular MSC implementation.

The BSS 104 comprises a Base Station Transceiver 112 to which the mobile device 102 is communicatively coupled. It is presumed that the coupling is a wireless cellular link by way of a cellular tower (not illustrated), however other couplings may be employed. In a typical cellular environment, a Base Station Controller 114 controls base station operation. An attempt by the mobile device to make a call or access services, such as web services, messaging, video conferencing, data transfer, etc., the call is routed through the BST to the MSC 106; routing may be by way of wireless or wired communication. The MSC may manage many cell sites and associated base station subsystems.

Before allowing the mobile device to place a call or access services, the MSC 106 validates the mobile device 102 against several databases. Conventionally, the databases include the Home Location Register (HLR) 116, the Visitor Location Register (VLR) 118, the Authentication Center (AC) 120, and the Equipment Identity Register (EIR) 122.

The HLR 116 and VLR 118 operate together to permit both local telephone operation and roaming operation outside of one's local service area. The HLR is the location register to which a mobile subscriber is assigned for record purposes. Much information may be tracked, customer identify information, customer history, directory number, class of service, your current city, last known location of phone usage, international mobile equipment identity (IMEI), etc. The VLR is used by the MSC 106 to retrieve and possibly cache information about a mobile device not known to a local HLR, such as for a cellular telephone roaming in the local area. The VLR validates that your phone is currently valid, and retrieves sufficient information from the remote MSC to place your call.

The AC 120 performs the authentication of a mobile device for permission to make calls, use network services, etc. For example, the AC may engage in a challenge-response interrogation of the mobile device to validate the mobile device.

The EIR 122 maintains a list of mobile devices used to connect to the system 100, and which is also used to maintain lists of devices, which are stolen or need to be tracked. For example, the EIR lists stolen phones, faulty equipment, and telephone numbers known to have been used fraudulently.

Unfortunately, while many mobile devices have security features, such as power-on and usage passwords, such security features hamper the use and enjoyment of the device and thus are typically not used or otherwise deactivated. And, while the EIR may be used to prevent a mobile device declared lost or stolen from being used in the system 100, the EIR does not prevent the possessor of the mobile device from accessing personal and/or confidential data stored in the mobile device. It would be more convenient if security features could be activated when a mobile device is out of the control of its owner, e.g., when a cellular phone has been lost, stolen or misplaced. Conventional systems such as depicted in FIG. 1 do not provide such security.

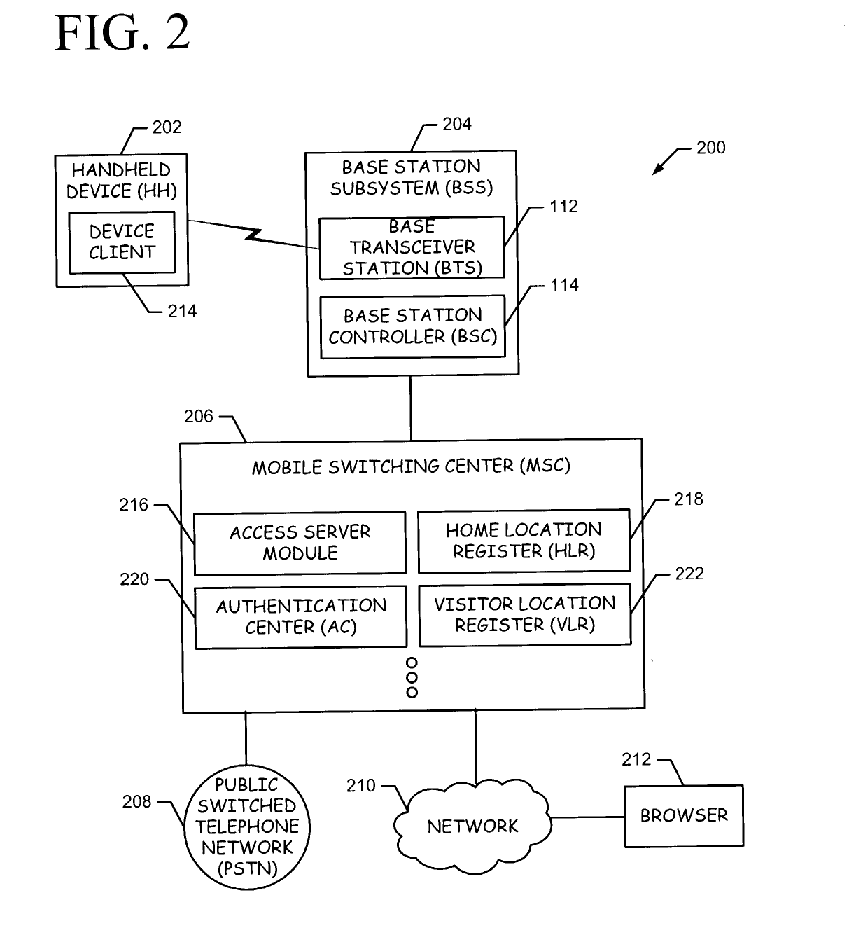

FIG. 2 illustrates a system 200 according to one embodiment that provides for securing a mobile device after it is out of the control of its owner, e.g., a phone that has been lost, stolen, misplaced, sent for service, or otherwise indisposed.

The illustrated system comprises a mobile device 202, such as a cellular phone or other device, a Base Station Subsystem (BSS) 204, a Mobile Switching Center (MSC) 206, a coupling to a Public Switched Telephone Network (PSTN) 208, and a coupling to a network 210, such as the Internet or other network. The ellipses in the MSC indicate other modules, not illustrated, may be present in the MSC. The PSTN and network illustrate exemplary communicative couplings for accessing or configuring security features for a mobile device. For example, a web browser 212 may be utilized by way of the network, or a voice response system (not illustrated) or human operator (not illustrated) may be utilized by way of the PSTN. It will be appreciated that other communication techniques may be employed; and, although the illustrated embodiment assumes a cellular network, it will be appreciated that this description and the claims that follow apply to other networks as well.

In contrast with a conventional system, such as the FIG. 1 system 100, in the illustrated system 200, the mobile device 202 is configured with a Device Client module 214 and the MSC 206 is configured with an Access Server module 216. In one embodiment, the Device Client and Access Server modules are communicatively coupled and operate to confirm security of the mobile device 202 before allowing access to personal and/or confidential data stored in or otherwise accessible by the mobile device.

In the illustrated embodiment, the Device Client 214 operates in conjunction with the mobile device. For example, the Device Client may be instructions executing within the mobile device, such as an add-on program, or program integrated within an operating system. Or, the Device Client may be instructions operating in conjunction with the mobile device, such as in a device inserted in or otherwise attached to or communicatively coupled with the mobile device. In one embodiment, the Device Client prevents access to data on the mobile device unless the device successfully registers with the system 200, e.g., a cellular network. As will be illustrated below, registration includes a handshake between the Device Client and the Access Server 216 component of the MSC 206 that validates the state of the mobile device, ensuring the owner has not secured the device remotely. If the mobile device owner has secured the device, such as via a web browser 212, PSTN 208 voice portal site, or by other means, the registration fails and the Device Client takes appropriate action.

Owner preferences may determine what action is appropriate, including disabling the mobile device entirely, partially disabling the mobile device, e.g., to allow emergency services such as contacting the police, or preventing access to some or all data stored within or associated with the mobile device, e.g., the phone may have access to external data sources. In one embodiment, security is dynamically activated when the mobile device loses its connection with the system 200. In one embodiment, the mobile device may be reactivated, e.g., security disabled, by entering an override code or password on the mobile device.

In the illustrated embodiment, the Access Server 216 operates in conjunction with the MSC 206. The Access Server 216 may use the HLR 218 and/or VLR 222 to find the identity of a subscriber running the Device Client 214. Once the Device Client identify is known, the Device Client can be signaled to enter a secured mode to prevent data access. In one embodiment, the Access Server operates along with the Home Location Register (HLR) 218 and Authentication Center (AC) 220 in a cellular network. In one embodiment, the Access Server can be accessed or configured by way of the PSTN 208 or network 210 to set security features of the mobile device 202. For example, an owner of the mobile device can access the Access Server through an Internet browser 212 over the network 210, enter a pin or otherwise validate with the Access Server, and designate a desired security level for the phone, e.g., to set the appropriate action to be taken if there is an attempt to register the mobile device with the system 200.

Thus, a registration process for a mobile device can be used to secure the mobile device in the event that control or possession of the device is lost. In a cellular context, the mobile device executes the Device Client 214 which communicates with the Mobile Switching Center (MSC) 206 Access Server 216, which as illustrated, operates in conjunction with the Home Location Register (HLR) 218 or Authentication Center (AC) 220. When the mobile device is activated, it attempts to register with the system 200, e.g., a cellular phone registers with the Home Location Register (HLR) 218 and authenticates with the Authentication Center (AC) 220. Registration, and access to data within the mobile device, will fail if security has been enabled for the mobile device.

The following two flowcharts illustrate in more detail various principles of operation of the invention.

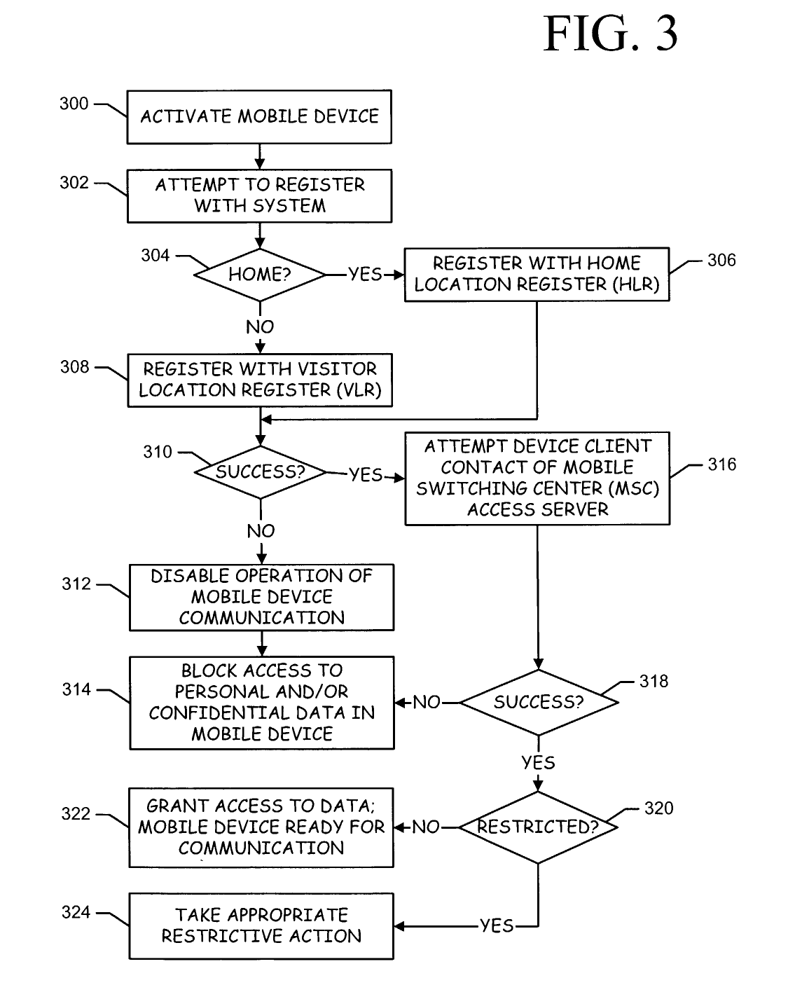

FIG. 3 is a flowchart illustrating activation 300 of a mobile device, such as a cellular telephone, in the FIG. 2 system 200. Activation may take many forms, including powering on the mobile device from a powered-off state, entering into a service area from a non-service area, and waking up from a low-power state.

After activating 300 the mobile device, the mobile device attempts to register 302 with the system 200. A check 304 is performed to determine whether the mobile device is in its home system. If yes, the mobile device attempts to register 306 with the Home Location Register (HLR) 218 of the Mobile Switching Center (MSC) 218. If not, the mobile device is roaming in a foreign system, and attempts to register 308 with the Visitor Location Register (VLR) 222.

A check 310 may be performed to determine whether registration 302 of the mobile device succeeded. If not, then operation of features of the mobile device requiring registration are disabled 312, e.g., in a cellular device, cellular communication abilities are wholly or partially restricted, and access to personal and/or confidential data in the mobile device is blocked 314. If registration succeeded, then the Device Client 214 of the mobile device may attempt to contact 316 the Access Server 216 of the MSC 218 to determine whether the owner of the mobile device has secured the phone, e.g., used a web browser 212 or PSTN 208 to indicate that the phone has been lost, stolen, misplaced, etc.

A check 318 is performed to determine whether the Device Client 214 was able to contact the Access Server 216. If not, access to personal and/or confidential data is blocked 314. If yes, a check 320 is performed to determine whether access to the personal and/or confidential data has been restricted. If not, then access to the data is granted 322, and since registration succeeded, the mobile device is ready to be used. If yes, then appropriate action is taken 320, which may correspond to an action set by the owner of the device, a default action by the system, or some combination of the two.

Note that while the illustrated embodiment shows Device Client operation 316 as occurring after determining 310 successful registration 302 of the mobile device with the system 200, it will be appreciated that operation of the Device Client may occur before or in parallel with the registration of the mobile device.

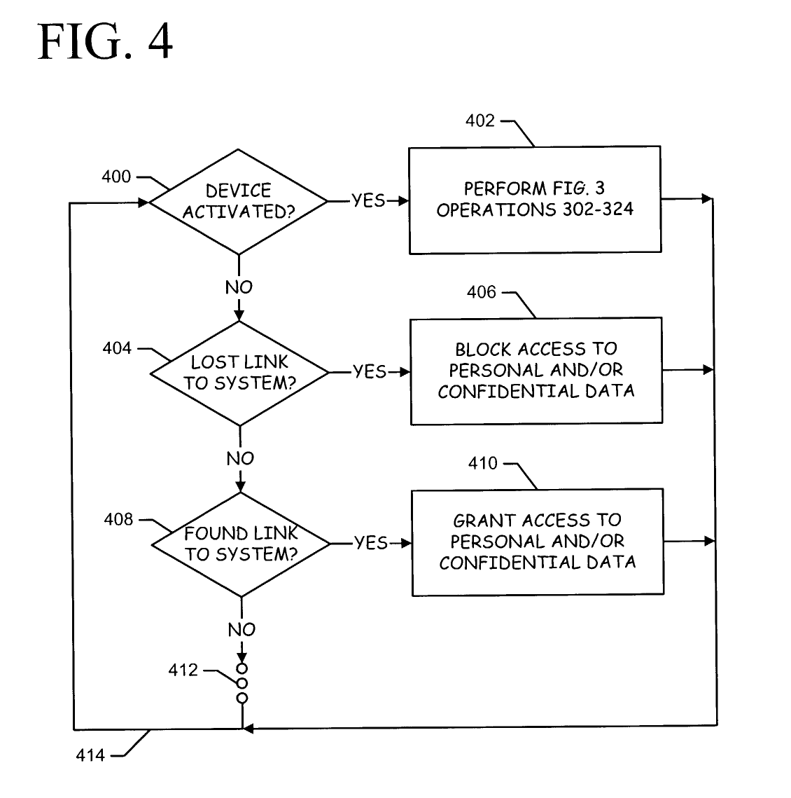

For example, FIG. 4 illustrates a flowchart according to one embodiment for a Device Client 214 operating asynchronously to the operation of the mobile client. In this embodiment, the Device Client loops through certain events of interest and acts when necessary to validate access to personal and/or confidential data within the mobile device. Although only two events of interest are illustrated, it will be appreciated that any number of events may trigger activity of the Device Client.

A first check 400 is determining whether the mobile device has been activated, e.g., FIG. 3 item 300. Determination may be performed in a variety of manners known in the art, including polling the status of the mobile device, receiving an event notification indicating activation of the mobile device, or through other means. If activation has occurred, then the Device Client acts 402 as described above for FIG. 3, operations 302-324, e.g., checks 310 registration success, contacts 316 the Access Server 216, checks 320 whether access to the personal and/or confidential data has been restricted, and grants access accordingly.

If the check 400 is not satisfied, or after its processing, then the next event of interest to the Device Client is checked 404, which as illustrated, is determining whether the mobile device has lost its link to the system 200. If so, then access to the personal and/or confidential data may be blocked 406 until the connection is restored, which would trigger another mobile device registration.

If the check 404 is not satisfied, or after its processing, then the next event of interest to the Device Client is checked 408, which as illustrated, is determining whether a lost connection to a communication system has been restored, and if so, then access to the data is again validated as discussed above with the mobile device's Device Client contacting the MSC's Access Server (see, e.g., FIG. 3 item 316), and assuming validation, access is granted 410.

If the check 408 is not satisfied, or after its processing, then another event of interest (not illustrated), if any, may be checked 412, until all events have been checked and processing loops 414 for checking other events. It will be appreciated that although FIG. 4 illustrates the checks 400, 404, 408 as occurring sequentially, these checks may be performed in parallel or in another order.

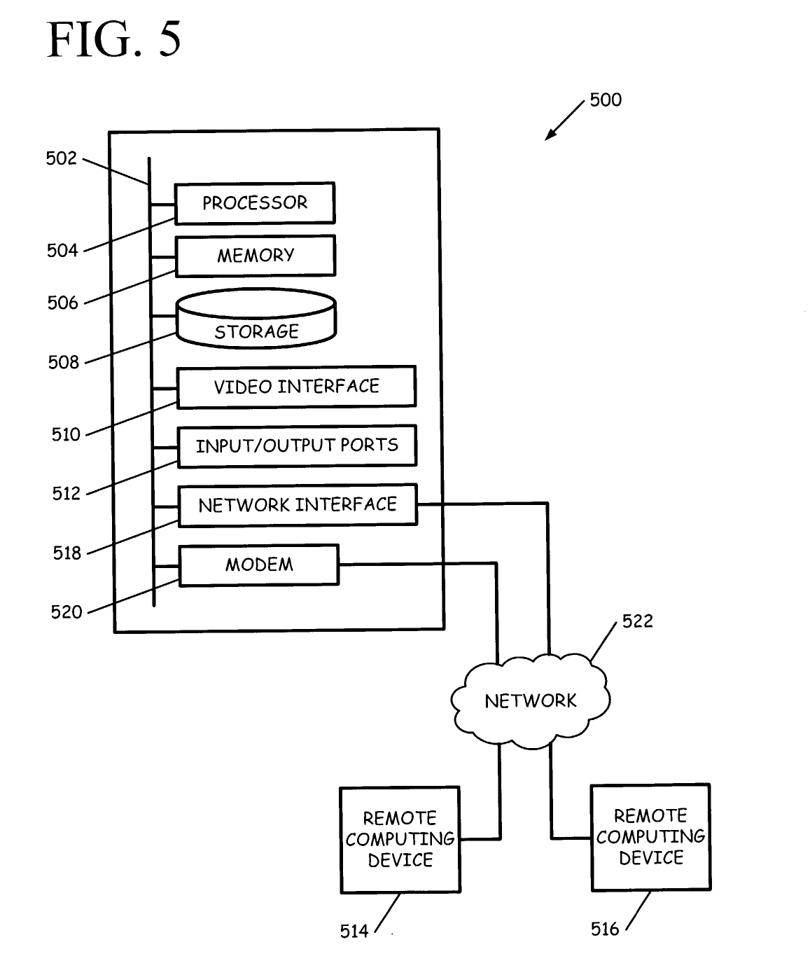

FIG. 5 and the following discussion are intended to provide a brief, general description of a suitable computing environment in which certain aspects of the illustrated invention may be implemented. For example, the illustrated environment includes a machine 500 which may embody various disclosed devices, such as the mobile device 202, Base Station Subsystem (BSS) 204, or Mobile Switching Center 206 of FIG. 2. Although these devices 202-206 may be implemented on different scales, they may share logical and/or physical structure.

As used herein, the term “machine” includes a single machine, such as a computer, workstation, server, handheld device, personal digital assistant, etc., or a system of communicatively coupled machines or devices. Typically, the machine 500 includes a system bus 502 to which is attached processors 504, a memory 506 (e.g., random access memory (RAM), read-only memory (ROM), or other state preserving medium), storage devices 508, a video interface 510, and input/output interface ports 512. The machine may be controlled, at least in part, by input from conventional input devices, such as keyboards, mice, joysticks, as well as directives received from another machine, interaction with a virtual reality (VR) environment, biometric feedback, or other input source or signal.

The machine is expected to operate in a networked environment using physical and/or logical connections to one or more remote machines 514, 516 through a network interface 518, modem 520, or other data pathway. Machines may be interconnected by way of a wired or wireless network 522, such as the network 210 of FIG. 2, an intranet, the Internet, local area networks, and wide area networks. It will be appreciated that network 522 may utilize various short range or long range wired or wireless carriers, including cellular, cable, laser, satellite, microwave, Bluetooth, optical, radio frequency (RF), and infrared. Thus, for example, with respect to the illustrated embodiments, assuming machine 500 embodies the Mobile Switching Center (MSC) 206 of FIG. 2, then remote machines 514, 516 may be two cellular telephones utilizing device clients 214 seeking to authenticate with the MSC.

The invention may be described by reference to or in conjunction with program modules, including functions, procedures, data structures, application programs, etc. for performing tasks, or defining abstract data types or low-level hardware contexts. Program modules may be stored in memory 506 and/or storage devices 508 and associated storage media, e.g., hard-drives, floppy-disks, optical storage, magnetic cassettes, tapes, flash memory cards, memory sticks, digital video disks, biological storage. Program modules may be delivered over transmission environments, including network 522, in the form of packets, serial data, parallel data, propagated signals, etc. Program modules may be used in a compressed or encrypted format, and may be used in a distributed environment and stored in local and/or remote memory, for access by single and multi-processor machines, portable computers, handheld devices, e.g., Personal Digital Assistants (PDAs), cellular telephones, etc.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for securing data associated with a mobile device operating in a system including the mobile device and an authentication center, the method comprising:
securing the data associated with the mobile device;
attempting registration of the mobile device with the system;
attempting to contact the authentication center to determine if the mobile device is secured or unsecured; and
allowing unrestricted access to the data if registration succeeds and the mobile device is determined to be unsecured.

2. The method of claim 1, further comprising:
restricting access to the data if the mobile device is determined to be secured.

3. The method of claim 1, further comprising:
receiving a security level indicator from the authentication center identifying a degree of access allowed to the data; and
restricting access to the data in accord with the degree of access.

4. The method of claim 1, further comprising:
restricting access to the data if the mobile device loses contact with the system.

5. The method of claim 1, wherein the data comprises data stored external to the mobile device but accessible by the mobile device.

6. The method of claim 1, further comprising:
prompting for a bypass code to access the data if registration fails.

7. The method of claim 1, further comprising:
prompting for a bypass code to access the data if the mobile device is determined to be unsecured.

8. The method of claim 1, further comprising:
prompting for a bypass code to access the data if the mobile device loses contact with the system.

9. The method of claim 1, further comprising:
performing the attempting to contact the authentication center asynchronously to performing the attempting registration of the mobile device.

10. A method for securing data associated with a mobile device operating in a system including the mobile device and an authentication center communicatively coupled with at a Public Switched Telephone Network (PSTN) and a network, the method comprising:
receiving a request to secure the mobile device over a selected one of the PSTN or the network;
receiving an attempt to contact the authentication center to determine if the mobile device is secured; and
replying to the attempt with an indicia that the mobile device is secured.

11. The method of claim 10, further comprising:
receiving a desired security setting along with the request to secure; and
configuring the indicia to comprise the desired security setting.

12. The method of claim 10, wherein the system further comprises a voice portal communicatively coupled with the PSTN.

13. The method of claim 10, wherein the system further comprises a web browser communicatively coupled with the network.

14. An article, comprising a machine-accessible media having associated data for securing data associated with a mobile device operating in a system including the mobile device and an authentication center, wherein the data, when accessed, results in a machine performing:
securing the data associated with the mobile device;
attempting registration of the mobile device with the system;
attempting to contact the authentication center to determine if the mobile device is secured or unsecured; and
allowing unrestricted access to the data if registration succeeds and the mobile device is determined to be unsecured.

15. The article of claim 14 wherein the machine-accessible media further includes data, when accessed by the machine, results in the machine performing:
restricting access to the data if the mobile device is determined to be secured.

16. The article of claim 14 wherein the machine-accessible media further includes data, when accessed by the machine, results in the machine performing:
receiving a security level indicator from the authentication center identifying a degree of access allowed to the data; and
restricting access to the data in accord with the degree of access.

17. The article of claim 14 wherein the machine-accessible media further includes data, when accessed by the machine, results in the machine performing:
restricting access to the data if the mobile device loses contact with the system.

18. The article of claim 14 wherein the machine-accessible media further includes data, when accessed by the machine, results in the machine performing:
prompting for a bypass code to access the data if registration fails.

19. The article of claim 14 wherein the machine-accessible media further includes data, when accessed by the machine, results in the machine performing:
prompting for a bypass code to access the data if the mobile device is determined to be unsecured.

20. The article of claim 14 wherein the machine-accessible media further includes data, when accessed by the machine, results in the machine performing:
prompting for a bypass code to access the data if the mobile device loses contact with the system.

21. An article, comprising a machine-accessible media having associated data for securing data associated with a mobile device operating in a system including the mobile device and an authentication center communicatively coupled with at a Public Switched Telephone Network (PSTN) and a network, wherein the data, when accessed, results in a machine performing:
receiving a request to secure the mobile device over a selected one of the PSTN or the network;
receiving an attempt to contact the authentication center to determine if the mobile device is secured; and
replying to the attempt with an indicia that the mobile device is secured.

22. The article of claim 21 wherein the machine-accessible media further includes data, when accessed by the machine, results in the machine performing:
receiving a desired security setting along with the request to secure; and
configuring the indicia to comprise the desired security setting.

23. A system communicatively coupled with a network, the system comprising:
a mobile device; and
an authentication center communicatively coupled with the mobile device and the network, the authentication center operable to perform:
receiving a request over the network to secure the mobile device;
receiving an attempt to determine if the mobile device is secured; and
replying to the attempt with indicia that the mobile device is secured.

24. The system of claim 23, wherein the mobile device is operable to perform:
receiving the indicia that the mobile device is secured; and
preventing access to data associated with the mobile device in response to receiving the indicia.

25. The system of claim 24, wherein the mobile device is operable to perform:
transmitting the attempt to determine if the mobile device is secured.

26. The system of claim 23, wherein the network comprises selected ones of a wired network, a wireless network, and a Public Switched Telephone Network (PSTN).

27. The system of claim 23, further comprising:
a voice portal communicatively coupled with the network and operable to generate the request to secure the mobile device.

28. The system of claim 23, further comprising:
a web server communicatively coupled with the network and operable to receive the request to secure the mobile device.

29. The system of claim 23, wherein the authentication center is further operable to perform:
receiving a desired security setting along with the request to secure; and
configuring the indicia to comprise the desired security setting.
